(19) United States
(12) Patent Application Publication
(10) Pub. No.: US 2026/0303231 A1
(43) Pub. Date: Oct. 1, 2026

(54) LINK QUALITY MONITORING ON MULTIPLE CANDIDATE CELL GROUPS

(71) Applicant: APPLE INC., Cupertino, CA (US)

(72) Inventors: Qiming Li, Beijing (CN); Yang Tang, San Jose, CA (US); Jie Cui, San Jose, CA (US); Dawei Zhang, Saratoga, CA (US); Manasa Raghavan, Sunnyvale, CA (US); Fangli Xu, Beijing (CN); Rolando E Bettancourt Ortega, Munich (DE); Yuexia Song, Beijing (CN); Naveen Kumar R Palle Venkata, San Diego, CA (US); Yuqin Chen, Beijing (CN); Xiang Chen, Campbell, CA (US)

(21) Appl. No.: 18/998,208

(22) PCT Filed: Aug. 9, 2022
(86) PCT No.: PCT/CN2022/111144

§ 371 Date: Jan. 24, 2025

(51) Int. Cl. H04B 17/309; H04L 5/00; H04W 8/24

(52) U.S. Cl. CPC H04B 17/309; H04L 5/0048; H04W 8/24

(57) ABSTRACT

Methods and apparatus are provided for a user equipment (UE) to monitor link quality on multiple candidate cell groups (CGs) in a wireless network. The UE sends, from the UE to a base station, a UE capability message indicating a number of the candidate CGs for which the UE supports at least one of simultaneous radio link monitoring (RLM) and simultaneous beam failure detection (BFD). The UE processes, at the UE, a configuration by the base station for measuring reference signals corresponding to a plurality of deactivated cells up to the number of the candidate CGs indicated by the UE capability message. The UE measures the reference signals according to the configuration.

### TECHNICAL FIELD

This application relates generally to wireless communication systems, including link quality monitoring.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a flowchart of a method for a UE to monitor link quality on multiple candidate cell groups (CGs) in a wireless network according to one embodiment.

FIG. 2 is a flowchart of a method for a base station in a wireless network according to one embodiment.

FIG. 3A, FIG. 3B, and FIG. 3C illustrate example scaling of an evaluation period with the number of candidate primary secondary cells (PSCells) according to one embodiment.

FIG. 4A, FIG. 4B, and FIG. 4C illustrate examples of prioritized scaling of an evaluation period according to one embodiment.

FIG. 5A, FIG. 5B, and FIG. 5C illustrate examples of prioritized scaling of an evaluation period without an increase in UE power consumption according to one embodiment.

FIG. 6 is a flowchart of a method for a UE to monitor multiple candidate CGs in a wireless network according to one embodiment.

FIG. 7 is a flowchart of a method for a base station in a wireless network according to one embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Certain embodiments disclosed herein provide solutions for performing radio link monitoring (RLM) and beam failure detection (BFD) on multiple candidate secondary cell groups (SCGs).

In NR communication systems, support of multiple candidate SCGs may be provided for mobility enhancement. For example, NR-NR dual connectivity (NR-DC) with selective activation of cell groups (at least for SCG) may include Layer 3 (L3) enhancements to allow subsequent cell group change after changing a carrier group (CG) without reconfiguration and re-initiation of conditional primary secondary cell (PSCell) change (CPC) and/or conditional PSCell addition (CPA). Enhancements may also include, for example, specifying conditional handover (CHO) including a target master cell group (MCG) and target secondary cell groups (SCGs), specifying CHO including a target MCG and candidate SCGs for CPC and/or CPA in NR-DC (e.g., CHO including the target MCG and target SCG used as a baseline), and/or specifying radio resource management (RRM) core requirements, as needed, for Layer 1 and/or Layer 2 (L1/L2) based inter-cell mobility and enhanced CHO configurations.

According to certain NR embodiments, a UE only supports one active SCG, even when multiple candidate SCGs can be configured. In such systems, however, it is unclear how to handle other candidate SCGs. Under a first option, for example, all other candidate SCGs are considered deactivated serving CGs, which has a benefit that a deactivated SCG can be activated quickly. In a second option, all other candidate SCGs are considered normal neighbor cells, which has a benefit of UE power saving. A difference between the first option and the second option is that the network can configure RLM and/or BFD on deactivated PSCells to determine that there is no link quality issue when activating one of the candidate PSCells. Further, UE RRM measurement requirements for deactivated PSCells are different from that of neighbor cells.

TABLE 1 shows example synchronization signal block (SSB) based RLM requirements for deactivated PSCell. Specifically, TABLE 1 shows evaluation periods T_{Evaluate_out_SSB} and T_{Evaluate_in_SSB} for FR1 for various discontinuous reception (DRX) configurations (where “Ceil” is a ceiling function, “out” refers to out-of-sync evaluation, “in” refers to in-sync evaluation, and “P” is a ratio of a total number of RLM-RS resource occasions within a window (including those overlapped with measurement gap occasions within the window) to the number of RLM-RS resource occasions that are not overlapped with any measurement gap occasion within the window). A UE is able to evaluate whether the downlink radio link quality on the configured RLM reference signal (RLM-RS) resource estimated over the last T_{Evaluate_out_SSB} period becomes worse than a quality threshold Q_{out_SSB} within the T_{Evaluate_out_SSB} evaluation period. Further, the UE is able to evaluate whether the downlink radio link quality on the configured RLM-RS resource estimated over the last T_{Evaluate_in_SSB} period becomes better than a quality threshold Q_{in_SSB} within the T_{Evaluate_in_SSB} evaluation period.

TABLE 1 corresponds, for example, to 3GPP Technical Specification (TS) 38.133 Table 8.1.2.2-4. Similar examples may be found in 3GPP TS 38.133, clauses 8.1.2 and 8.1.3, for SSB based RLM for deactivated PSCell for FR2 (Table 8.1.2.2-5), channel state information (CSI)-reference signal (RS) based RLM for deactivated PSCell for FR1 (Table 8.1.3.2-3), CSI-RS based RLM for deactivated PSCell for FR2 (Table 8.1.3.2-4), SSB based BFD for deactivated PSCell in FR1 (Table 8.5.2.2-4), SSB based BFD for deactivated PSCell in FR2 (Table 8.5.2.2-5), CSI-RS based BFD for deactivated PSCell in FR1 (Table 8.5.3.2-3), and CSI-RS based BFD for deactivated PSCell in FR2 (Table 8.5.3.2-4).

TABLE 1

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Ceil(10 x P) x measCyclePSCell | Ceil(5 x P) x measCyclePSCell |
| DRX cycles ≤ [320]ms | Ceil(10 x P) x Max(1.5 x T_{DRX}, measCyclePSCell) | Ceil(5 x P) x Max(1.5 x T_{DRX}, measCyclePSCell) |
| DRX cycle > [320]ms | Ceil(10 x P) x Max(T_{DRX}, measCyclePSCell) | Ceil(5 x P) x Max(T_{DRX}, measCyclePSCell) |

NOTE:
T_{DRX} is the DRX cycle length of SCG. measCyclePSCell is the measurement cycle length of the deactivated PSCell.

### Simultaneous RLM and BFD on Multiple Candidate/Deactivated PSCells.

In certain embodiments, a UE performs RLM and BFD simultaneously on multiple candidate PSCells and/or deactivated PSCells. The RLM and BFD may, for example, at least partially overlap in time. Thus, the efficiency and robustness of the RLM and BFD may be increased. However, simultaneous RLM and BFD on multiple candidate and/or deactivated PSCells may increase UE power consumption.

In certain NR systems, a measurement cycle length (measCyclePSCell shown in TABLE 1) may be configured per measurement object (MO). In certain embodiments disclosed herein, however, the measurement cycle length is configured per cell. This allows the network to configure different parameters for different candidate PSCells.

For example, the measurement cycle length in TABLE 2 is shown with an index (i) (e.g., measCyclePSCellᵢ) to indicate that it corresponds to the measurement cycle length of the deactivated PSCellᵢ. The example in TABLE 2 is for SSB based RLM for deactivated PSCell in FR1. Similar changes may be made, for example, to 3GPP TS 38.133 Table 8.1.2.2-5, Table 8.1.3.2-3, Table 8.1.3.2-4, Table 8.5.2.2-4, Table 8.5.2.2-5, Table 8.5.3.2-3, and Table 8.5.3.2-4. Thus, the RRM requirements for RLM and BFD are updated per serving cell requirements.

TABLE 2

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Ceil(10 x P) x measCyclePSCellᵢ | Ceil(5 x P) x measCyclePSCellᵢ |
| DRX cycles ≤ [320]ms | Ceil(10 x P) x Max(1.5 x T_{DRX}, measCyclePSCellᵢ) | Ceil(5 x P) x Max(1.5 x T_{DRX}, measCyclePSCellᵢ) |
| DRX cycle > [320]ms | Ceil(10 x P) x Max(T_{DRX}, measCyclePSCellᵢ) | Ceil(5 x P) x Max(T_{DRX}, measCyclePSCellᵢ) |

NOTE:
T_{DRX} is the DRX cycle length of SCG. measCyclePSCellᵢ is the measurement cycle length of the deactivated PSCellᵢ.

Alternatively, a new information element (IE) may be used to control the RLM and BFD evaluation period (e.g., RLMCyclePSCell and/or BFDCyclePSCell in the RLM and BFD configuration). Thus, the network can configure different parameters for different candidate PSCells.

In certain embodiments, the base station signals to the UE to perform RLM and BFD simultaneously on multiple candidate PSCells and/or deactivated PSCells. In one such embodiment, the base station sends an indication to the UE to perform BFD and RLM on a deactivated SCG as part of candidate SCG selection, and uses the candidate SCG selection process to report the candidate beam information, if configured. For example, a deactivated SCG configuration IE (DeactivatedSCG-Config) may include a parameter bfdRLM-ForSCG to indicate to the UE to perform BFD and RLM on the indicated SCG, and a reportBeams parameter to indicated to the UE to report the candidate beam information, as shown below:

| DeactivatedSCG-Config-r17 ::= | SEQUENCE { |
|---|---|
| bfd-and-RLM | BOOLEAN, |
| ..., | |
| [[ | |
| bfdRLM-ForSCG—r18 | BOOLEAN, |
| reportBeams-r18 | BOOLEAN |

]]
}.

In another embodiment, the base station signals a cell level measurement cycle length (measCyclePSCell) to the UE. For example, a deactivated SCG configuration IE (DeactivatedSCG-Config) may include the parameter measCyclePSCell, which is configured per cell, as shown below:

| | |
|---|---|
| DeactivatedSCG-Config-r17 ::= | SEQUENCE { |
| bfd-and-RLM | BOOLEAN, |

```
    ...,
    [[
```

| | |
|---|---|
| measCyclePSCell-r18 | ENUMERATED {sf160, sf256, sf320, sf512, |

```
sf640, sf1024, sf1280}
    ]]
  }.
```

In another embodiment, the base station signals a cell level BFD measurement cycle length (bfdMeasCycle) and/or RLM measurement cycle length (rlmMeasCycle) to the UE. For example, a deactivated SCG configuration IE (DeactivatedSCG-Config) may include the parameter bfdMeasCycle and the parameter rlmMeasCycle, which are configured per cell, as shown below:

| | |
|---|---|
| DeactivatedSCG-Config-r17 ::= | SEQUENCE { |
| bfd-and-RLM | BOOLEAN, |

```
    ...,
  [[
```

| | |
|---|---|
| bfdMeasCycle-r18 | ENUMERATED {sf160, sf256, sf320, sf512, sf640, |

sf1024, sf1280} OPTIONAL,

| | |
|---|---|
| rlmMeasCycle-r18 | ENUMERATED {sf160, sf256, sf320, sf512, sf640, |

```
sf1024, sf1280} OPTIONAL,
    ]]
  }.
```

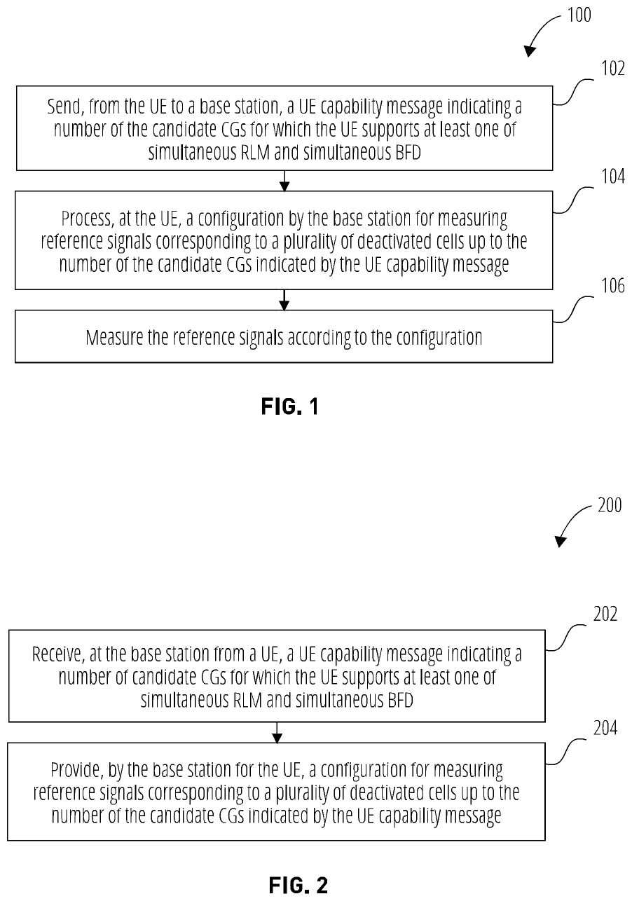

FIG. 1 is a flowchart of a method 100 for a user equipment (UE) to monitor link quality on multiple candidate cell groups (CGs) in a wireless network according to one embodiment. In block 102, the method 100 includes sending, from the UE to a base station, a UE capability message indicating a number of the candidate CGs for which the UE supports at least one of simultaneous radio link monitoring (RLM) and simultaneous beam failure detection (BFD). In block 104, the method 100 includes processing, at the UE, a configuration by the base station for measuring reference signals corresponding to a plurality of deactivated cells up to the number of the candidate CGs indicated by the UE capability message. In block 106, the method 100 includes measuring the reference signals according to the configuration.

In certain embodiments of the method 100, the configuration comprises measurement cycle length values configured per cell of the plurality of deactivated cells.

In certain embodiments of the method 100, the configuration comprises a deactivated secondary cell group (SCG) configuration information element (IE), received by the UE from the base station, for each of the plurality of deactivated cells.

In certain embodiments, the deactivated SCG configuration IE comprises a first indication that the UE is to perform the BFD or the RLM on a corresponding deactivated SCG as part of a candidate SCG selection process. The deactivated SCG configuration IE may further comprise a second indication that the UE is to report candidate beam information for the corresponding deactivated SCG.

In certain embodiments, the deactivated SCG configuration IE comprises a measurement cycle length of a deactivated primary secondary cell (PSCell).

In certain embodiments, the deactivated SCG configuration IE comprises at least one of a BFD measurement cycle length and a RLM measurement cycle length of a deactivated primary secondary cell (PSCell).

In certain embodiments of the method 100, the configuration comprises a deactivated master cell group (MCG) configuration information element (IE), received by the UE from the base station, for each of the plurality of deactivated cells.

In certain embodiments, the deactivated MCG configuration IE comprises a first indication that the UE is to perform the BFD or the RLM on a corresponding deactivated MCG as part of a candidate MCG selection process. The deactivated MCG configuration IE may further comprise a second indication that the UE is to report candidate beam information for the corresponding deactivated MCG.

In certain embodiments, the deactivated MCG configuration IE comprises a measurement cycle length of a deactivated primary cell (PCell).

In certain embodiments, the deactivated MCG configuration IE comprises at least one of a BFD measurement cycle length and a RLM measurement cycle length of a deactivated primary cell (PCell).

In certain embodiments of the method 100, the UE capability message comprises a single value for the number of the candidate CGs for which the UE supports at least one of the simultaneous RLM or the simultaneous BFD.

In certain embodiments of the method 100, the UE capability message comprises one of a per frequency range (FR) indication, a per band indication, a per band combination indication, and per band per band combination indication.

In certain embodiments, the method 100 further comprises, in response to determining that a relaxed measurement criteria is met, multiplying an evaluation period for measuring the reference signals by a multiplication value, wherein the multiplication value comprises a predetermined value or a configured value communicated to the UE by the base station.

FIG. 2 is a flowchart of a method 200 for a base station in a wireless network according to one embodiment. In block 202, the method 200 includes receiving, at the base station from a user equipment (UE), a UE capability message indicating a number of candidate cell groups (CGs) for which the UE supports at least one of simultaneous radio link monitoring (RLM) and simultaneous beam failure detection (BFD). In block 204, the method 200 includes providing, by the base station for the UE, a configuration for measuring reference signals corresponding to a plurality of deactivated cells up to the number of the candidate CGs indicated by the UE capability message.

In certain embodiments of the method 200, the configuration comprises measurement cycle length values configured per cell of the plurality of deactivated cells.

In certain embodiments of the method 200, the configuration comprises a deactivated secondary cell group (SCG) configuration information element (IE) for each of the plurality of deactivated cells.

In certain embodiments, the deactivated SCG configuration IE comprises a first indication that the UE is to perform the BFD or the RLM on a corresponding deactivated SCG as part of a candidate SCG selection process. The deactivated SCG configuration IE may further comprise a second indication that the UE is to report candidate beam information for the corresponding deactivated SCG.

In certain embodiments, the deactivated SCG configuration IE comprises a measurement cycle length of a deactivated primary secondary cell (PSCell).

In certain embodiments, the deactivated SCG configuration IE comprises at least one of a BFD measurement cycle length and a RLM measurement cycle length of a deactivated primary secondary cell (PSCell).

In certain embodiments of the method 200, the configuration comprises a deactivated master cell group (MCG) configuration information element (IE) for each of the plurality of deactivated cells.

In certain embodiments, the deactivated MCG configuration IE comprises a first indication that the UE is to perform the BFD or the RLM on a corresponding deactivated MCG as part of a candidate MCG selection process. The deactivated MCG configuration IE may further comprise a second indication that the UE is to report candidate beam information for the corresponding deactivated MCG.

In certain embodiments, the deactivated MCG configuration IE comprises a measurement cycle length of a deactivated primary cell (PCell).

In certain embodiments, the deactivated MCG configuration IE comprises at least one of a BFD measurement cycle length and a RLM measurement cycle length of a deactivated primary cell (PCell).

In certain embodiments of the method 200, the UE capability message comprises a single value for the number of the candidate CGs for which the UE supports at least one of the simultaneous RLM or the simultaneous BFD. The UE capability message may comprise one of a per frequency range (FR) indication, a per band indication, a per band combination indication, and per band per band combination indication.

In certain embodiments, the method 200 further comprises configuring the UE to perform at least one of relaxed RLM and relaxed BFD, when a relaxed measurement criteria is met, by multiplying an evaluation period for measuring the reference signals by a multiplication value, wherein the multiplication value comprises a predetermined value or a configured value signaled by the base station to the UE.

Scale Evaluation Period with the Number of PSCells.

In certain embodiments, the UE is configured to scale the RLM and/or BFD evaluation period with the number of candidate PSCells. Increasing the RLM and/or BFD evaluation period based on the number of candidate PSCells may result in little or no extra UE power consumption. However, in certain implementations, there may potentially be a degradation of RLM and/or BFD efficiency and robustness.

For example, the evaluation periods (T_{Evaluate_out_SSB} and T_{Evaluate_in_SSB}) in TABLE 3 is scaled by an integer N, which is the number of PSCells on which the UE is configured to perform RLM. The example in TABLE 3 is for SSB based RLM for deactivated PSCell in FR1. Similar changes may be made, for example, to 3GPP TS 38.133 Table 8.1.2.2-5, Table 8.1.3.2-3, Table 8.1.3.2-4, Table 8.5.2.2-4, Table 8.5.2.2-5, Table 8.5.3.2-3, and Table 8.5.3.2-4.

TABLE 3

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | N x Ceil(10 x P) x measCyclePSCell | N x Ceil(5 x P) x measCyclePSCell |
| DRX cycles ≤ [320]ms | N x Ceil(10 x P) x Max(1.5 x T_{DRX}, measCyclePSCell) | N x Ceil(5 x P) x Max(1.5 x T_{DRX}, measCyclePSCell) |
| DRX cycle > [320]ms | N x Ceil(10 x P) x Max(T_{DRX}, measCyclePSCell) | N x Ceil(5 x P) x Max(T_{DRX}, measCyclePSCell) |

NOTE1:
T_{DRX} is the DRX cycle length of SCG. measCyclePSCell is the measurement cycle length of the deactivated PSCell.
NOTE2:
N is the number of PSCells on which the UE is configured to perform RLM.

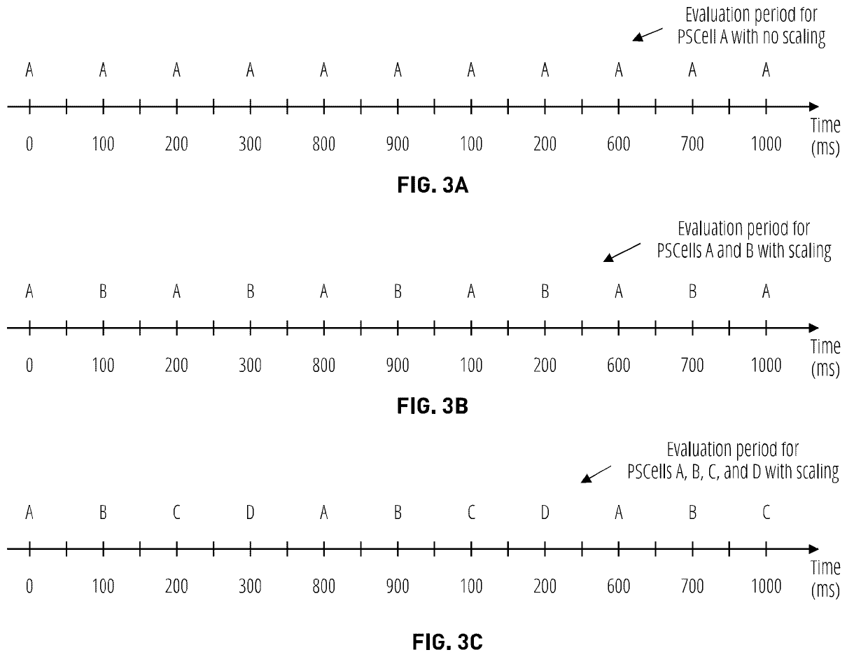

FIG. 3A, FIG. 3B, and FIG. 3C illustrate example scaling of an evaluation period with the number of candidate PSCells according to one embodiment. To simplify the discussion of the illustrated examples herein, an evaluation period without scaling is given as 100 milliseconds (ms). However, the disclosure is not so limited, and skilled persons will recognize that shorter or longer RLM and/or BFD evaluation periods may be used. Thus, in FIG. 3A, a UE evaluates a single candidate PSCell A every 100 ms (for illustration “A” is shown every 100 ms), e.g., to determine whether the downlink radio link quality on the configured RLM-RS resource estimated over the last evaluation period becomes worse than a quality threshold within the evaluation period).

In the example shown in FIG. 3B, the UE evaluates both the candidate PSCell A and another candidate PSCell B. As there are two PSCells for RLM and/or BFD evaluation, the UE scales the evaluation period by N=2. Thus, the evaluation period for both candidate PSCells A and B is increased from 100 ms to 200 milliseconds (i.e., “A” is shown every 200 ms and “B” is shown every 200 ms). Comparing the examples in FIG. 3A and FIG. 3B, the UE performs the same number of evaluations over time such that additional UE power is not consumed. However, there is a potential degradation of RLM and/or BFD performance as there may be increased latency before the UE determines that the downlink radio link quality has decreased.

The potential degradation RLM and/or BFD performance becomes worse as the number of candidate PSCells increases. In FIG. 3C, for example, the UE evaluates four candidate PSCells A, B, C, and D by scaling the evaluation period by N=4. Thus, the evaluation period for the candidate PSCells increases from 100 ms to 800 ms (i.e., “A” is shown every 400 ms, “B” is shown every 400 ms, “C” is shown every 800 ms, and “D” is shown every 800 ms), which may further increase the latency in detecting a decrease in downline radio quality.

### Prioritize RLM/BFD on Some PSCells.

In certain embodiments, the UE is configured to prioritize RLM and/or BFD on one or more the PSCells. A prioritized PSCell may be referred to herein as an anchor PSCell. In certain such embodiments, there may be no significant UE power consumption increase (or only an acceptable amount of increased UE power consumption), while maintaining RLM and/or BFD performance on target or prioritized PSCell(s).

For example, the evaluation period (T_{Evaluate_out_SSB} and T_{Evaluate_in_SSB}) in TABLE 4 is scaled by the integer N. For the anchor PSCell, N=1. For other PSCells, N is the number of non-anchor PSCells on which the UE is configured to perform RLM. The example in TABLE 4 is for SSB based RLM for deactivated PSCell in FR1. Similar changes may be made, for example, to 3GPP TS 38.133 Table 8.1.2.2-5, Table 8.1.3.2-3, Table 8.1.3.2-4, Table 8.5.2.2-4, Table 8.5.2.2-5, Table 8.5.3.2-3, and Table 8.5.3.2-4.

TABLE 4

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | N x Ceil(10 x P) x measCyclePSCell | N x Ceil(5 x P) x measCyclePSCell |
| DRX cycle ≤ [320]ms | N x Ceil(10 x P) x Max(1.5 x T_{DRX}, measCyclePSCell) | N x Ceil(5 x P) x Max(1.5 x T_{DRX}, measCyclePSCell) |
| DRX cycle > [320]ms | N x Ceil(10 x P) x Max(T_{DRX}, measCyclePSCell) | N x Ceil(5 x P)x Max(T_{DRX}, measCyclePSCell) |

NOTE1:
T_{DRX} is the DRX cycle length of SCG. measCyclePSCell is the measurement cycle length of the deactivated PSCell.
NOTE2:
For anchor PSCell, N = 1. For other PSCells, N is the number of non-anchor PSCells on which the UE is configured to perform RLM.

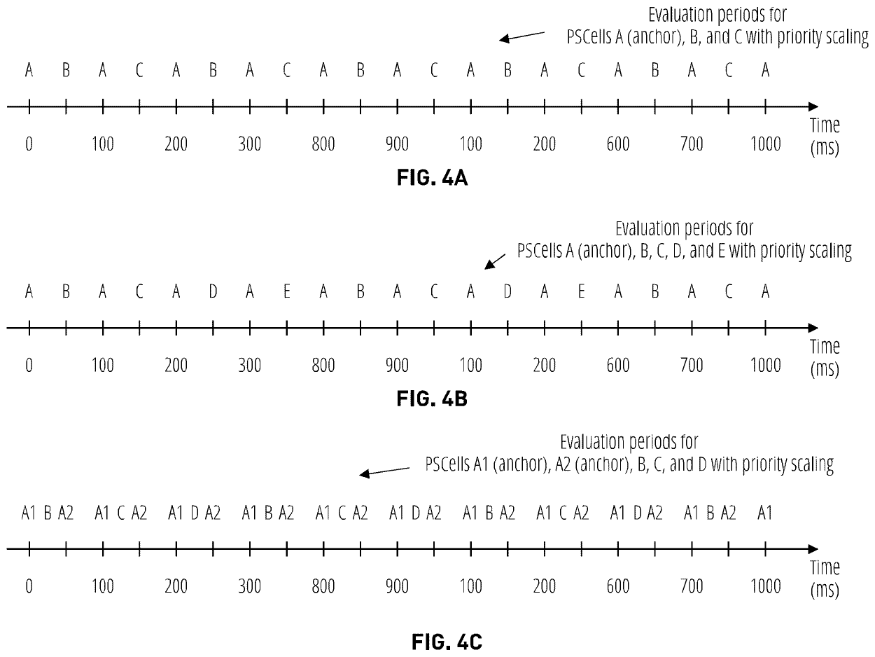

FIG. 4A, FIG. 4B, and FIG. 4C illustrate examples of prioritized scaling of an evaluation period according to one embodiment. In these examples, an evaluation period without scaling is given as 100 ms.

FIG. 4A shows an example of priority scaling for PSCell A (the prioritized or anchor cell), PSCell B, and PSCell C. As the anchor PSCell, N=1 for PSCell A. Thus, a UE evaluates PSCell A every 1×100 ms=100 ms (for illustration “A” is shown every 100 ms). As there are two non-anchor PSCells, N=2 for PSCell B and PSCell C, which corresponds to a scaled evaluation period of 2×100 ms=200 ms (i.e., “B” and “C” are shown every 200 ms). Thus, the UE maintains the RLM and/or BFD performance for PSCell A (i.e., no scaling), while providing reduced RLM and/or BFD performance for PSCell B and PSCell C. Compared to the examples shown in FIG. 3A to FIG. 3C, in the example shown in FIG. 4A the UE doubles the number of evaluations over the illustrated time (i.e., from every 100 ms to every 50 ms), which may be an acceptable increase in UE power consumption in certain embodiments.

FIG. 4B shows an example of priority scaling for PSCell A (the prioritized or anchor cell), PSCell B, PSCell C, PSCell D, and PSCell E. As the anchor PSCell, N=1 for PSCell A. Thus, the UE evaluates PSCell A every 1×100 ms=100 ms (i.e., “A” is shown every 100 ms). As there are four non-anchor PSCells, N=4 for PSCell B, PSCell C, PSCell D, and PSCell E, which corresponds to a scaled evaluation period of 4×100 ms=400 ms (i.e., “B”, “C”, “D”, and “E” are shown every 400 ms). Thus, the UE maintains the RLM and/or BFD performance for PSCell A (i.e., no scaling), while providing even further reduced RLM and/or BFD performance for PSCell B, PSCell C, PSCell D, and PSCell E. Comparing the examples in FIG. 4A and FIG. 4B, however, the UE power consumption for RLM and/or BFD does not significantly change when going from three PSCells to five PSCells, as the UE performs the same number of evaluations over the illustrated time.

In certain embodiments, the UE may prioritize more than one PSCell (i.e., more than one anchor PSCell). In certain such embodiments, N=1 for each of the anchor cells. For example, FIG. 4C shows an example of priority scaling for five PSCells, with two anchor PSCells (PSCell A1 and PSCell A2) and three non-anchor PSCells (PSCell B, PSCell C, and PSCell D). For anchor PSCell A1 and anchor PSCell A2, N=1. Thus, the UE evaluates PSCell A1 and PSCell A2 every 1×100 ms=100 ms (i.e., “A1” and “A2” are shown every 100 ms). As there are three non-anchor PSCells, N=3 for PSCell B, PSCell C, and PSCell D, which corresponds to a scaled evaluation period of 3×100 ms=300 ms (i.e., “B”, “C”, and “D” are shown every 300 ms). Thus, the UE maintains the RLM and/or BFD performance for PSCell A1 and PSCell A2 (i.e., no scaling), while providing a reduced RLM and/or BFD performance for PSCell B, PSCell C, and PSCell D. However, as compared to the examples shown in FIG. 4A and FIG. 4B, the UE performs more evaluations over the illustrated time.

To determine the anchor or prioritized PSCell(s), in one embodiment, signaling from the network to the UE is used to indicate on which PSCell(s) the RLM and/or BFD is prioritized. For example, a special cell configuration (SpCellConfig) IE for signaling from the base station to the UE may include an anchor SCG parameter (anchorSCG) to indicate a selected anchor PSCell on which the UE is to prioritize RLM and/or BFD, as shown below:

| SpCellConfig ::= | SEQUENCE { | |
|---|---|---|
| servCellIndex | ServCellIndex | OPTION |

AL, -- Cond SCG

| | |
|---|---|
| reconfigurationWithSync | ReconfigurationWithSync |

OPTIONAL, -- Cond ReconfWithSync

| rlf-TimersAndConstants | SetupRelease { RLF- | |
|---|---|---|
| TimersAndConstants } | OPTIONAL, -- Need M | |
| rlmInSyncOutOfSyncThreshold | ENUMERATED | |
| {n1} | OPTIONAL, -- Need S | |
| spCellConfigDedicated | ServingCellConfig | OP |

```
TIONAL, -- Need M
    ...,
    [[
```

| lowMobilityEvaluationConnected-r17 | SEQUENCE { | |
|---|---|---|
| s-SearchDeltaP-Connected-r17 | ENUMERATED {ffs}, | |
| t-SearchDeltaP-Connected-r17 | ENUMERATED {ffs} | |
| } | | OPTIONAL, -- |

Need R

| | |
|---|---|
| goodServingCellEvaluationRLM-r17 | GoodServingCellEvaluation- |
| r17 | OPTIONAL, -- Need R |
| goodServingCellEvaluationBFD-r17 | GoodServingCellEvaluation- |
| r17 | OPTIONAL, -- Need R |
| deactivatedSCG-Config-r17 | SetupRelease { DeactivatedSCG-Config- |
| r17 } | OPTIONAL -- Need M |

```
    ]],
    [[
```

| | |
|---|---|
| anchorSCG-r18 | ENUMERATED {true} |

```
    ]]
  }.
```

As another example, a deactivated SCG configuration IE (DeactivatedSCG-Config) for signaling from the base station to the UE may include an anchor SCG parameter (anchorSCG) to indicate a selected anchor PSCell on which the UE is to prioritize RLM and/or BFD, as shown below:

| DeactivatedSCG-Config-r17 ::= | SEQUENCE |
|---|---|
| bfd-and-RLM | BOOLEAN, |
| ..., | |
| [[ | |
| anchorSCG-r18 | ENUMERATED {true} |

]]
}.

To determine the anchor PSCell or prioritized PSCells, in other embodiments, the UE autonomously determines the anchor PSCell to use (i.e., without signaling from the network). In addition, the UE may report the selected PSCell for which the BFD and/or RLM is performed and above a threshold.

In a first example embodiment of UE autonomous based determination of an anchor PSCell or prioritized PSCells, the UE autonomously determines the anchor PSCell based on RRM measurement on each candidate PSCell. For example, the UE performs RRM measurement regularly on the candidate PSCells and considers the best PSCell as the anchor PSCell. Measurement metrics may include at least one of SSB based reference signal received power (RSRP), SSB based reference signal received quality (RSRQ), SSB based signal to noise and interference ratio (SINR), CSI-RS based RSRP, CSI-RS based RSRQ, and/or CSI-RS based SINR.

In a second example embodiment of UE autonomous based determination of an anchor PSCell or prioritized PSCells, the UE selects the prioritized PSCells from among those cells that are suitable (i.e., meet S criteria) or have a cell quality greater than or equal to a quality threshold. The quality threshold may be preconfigured by the network. In certain embodiments, the first example embodiment of UE autonomous based determination and the second example embodiment of UE autonomous based determination may be combined.

In addition, or in other embodiments, to determine the anchor PSCell or prioritized PSCells, both signaling from the network and UE autonomous based determination may be used. For example, a special cell configuration (SpCellConfig) IE for signaling from the base station to the UE may include a UE autonomous anchor SCG change flag (UEautonomousAnchorSCGChange) to instruct the UE to perform autonomous based determination of an anchor PSCell, as shown below:

| SpCellConfig ::= | SEQUENCE { | |
|---|---|---|
| servCellIndex | ServCellIndex | OPTION |

AL, -- Cond SCG

| | |
|---|---|
| reconfigurationWithSync | ReconfigurationWithSync |

OPTIONAL, -- Cond ReconfWithSync

| rlf-TimersAndConstants | SetupRelease { RLF- | |
|---|---|---|
| TimersAndConstants } | OPTIONAL, -- Need M | |
| rlmInSyncOutOfSyncThreshold | ENUMERATED | |
| {n1} | OPTIONAL, -- Need S | |
| spCellConfigDedicated | ServingCellConfig | OP |

```
TIONAL, -- Need M
    ...,
    [[
```

| lowMobilityEvaluationConnected-r17 | SEQUENCE { | |
|---|---|---|
| s-SearchDeltaP-Connected-r17 | ENUMERATED {ffs}, | |
| t-SearchDeltaP-Connected-r17 | ENUMERATED {ffs} | |
| } | | OPTIONAL, -- |

Need R

| | |
|---|---|
| goodServingCellEvaluationRLM-r17 | GoodServingCellEvaluation- |
| r17 | OPTIONAL, -- Need R |
| goodServingCellEvaluationBFD-r17 | GoodServingCellEvaluation- |
| r17 | OPTIONAL, -- Need R |
| deactivatedSCG-Config-r17 | SetupRelease { DeactivatedSCG-Config- |
| r17 } | OPTIONAL -- Need M |
| UEautonomousAnchorSCGChange | ENUMERATED {true} |

```
    ]]
  }.
```

In certain embodiments of UE autonomous based determination of an anchor PSCell or prioritized PSCells, the network prepares serving cells in the SCG to assume the role of PSCell. The choice by the UE on which serving cell is selected for the PSCell may be based on the random access channel (RACH) on that serving cell in the candidate SCG. The network may configure the PSCell handling related configuration to the serving cells in the candidate SCG. The configuration parameters may include, but are not limited to, cell radio network temporary identifier (C-RNTI) and common configuration of the cell. The UE may apply the configuration parameters before performing a RACH procedure in the UE's chosen serving cell as PSCell.

Certain embodiments prioritize RLM and/or BFD on some of the PSCells (e.g., on one or more anchor PSCells) with little or no increase in UE power consumption. In one such embodiment, for example, 50% of the measurement resources or sampling opportunities are assigned to the anchor PSCell(s) and the other 50% of measurement resources or sampling opportunities are shared among the non-anchor the PSCells.

For example, the evaluation period (T_{Evaluate_out_SSB} and T_{Evaluate_in_SSB}) in TABLE 5 is scaled by 2×N. For a single anchor PSCell, N=1. In certain embodiments with multiple anchor cells, n=k, where k is the number of anchor cells. For other PSCells, N is the number of non-anchor PSCells on which the UE is configured to perform RLM. The example in TABLE 5 is for SSB based RLM for deactivated PSCell in FR1. Similar changes may be made, for example, to 3GPP TS 38.133 Table 8.1.2.2-5, Table 8.1.3.2-3, Table 8.1.3.2-4, Table 8.5.2.2-4, Table 8.5.2.2-5, Table 8.5.3.2-3, and Table 8.5.3.2-4.

TABLE 5

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | 2 x N x Ceil(10 x P) x measCyclePSCell | 2 x N x Ceil(5 x P) x measCyclePSCell |
| DRX cycles ≤ [320]ms | 2 x N x Ceil(10 x P) x Max(1.5 x T_{DRX}, measCyclePSCell) | 2 x N x Ceil(5 x P) x Max(1.5 x T_{DRX}, measCyclePSCell) |
| DRX cycle > [320]ms | 2 x N x Ceil(10 x P) x Max(T_{DRX}, measCyclePSCell) | 2 x N x Ceil(5 x P) x Max(T_{DRX}, measCyclePSCell) |

NOTE1:
T_{DRX} is the DRX cycle length of SCG. measCyclePSCell is the measurement cycle length of the deactivated PSCell.
NOTE2:
For anchor PSCell, N = 1. For other PSCells, N is the number of non-anchor PSCells on which the UE is configured to perform RLM/BLM.

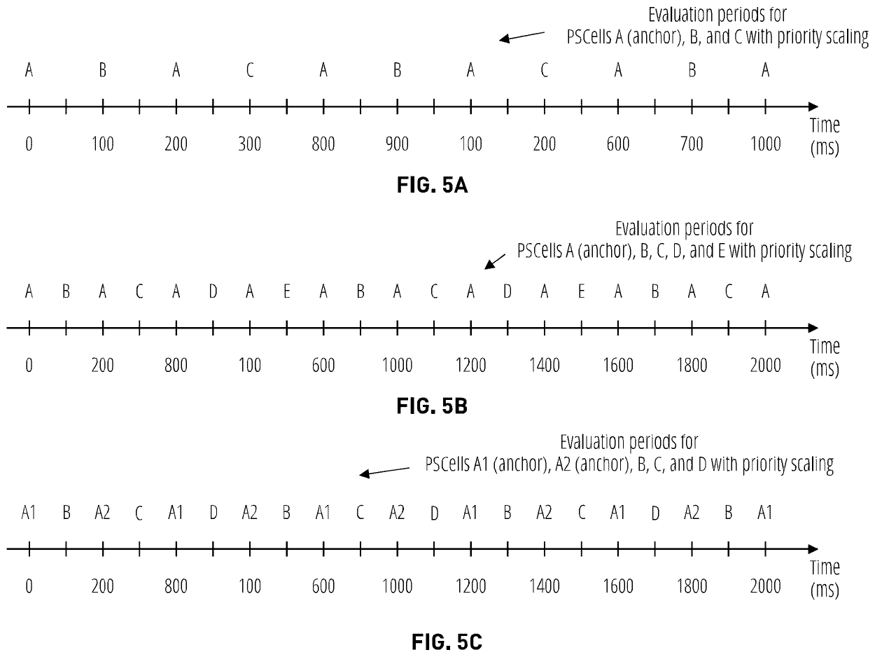

FIG. 5A, FIG. 5B, and FIG. 5C illustrate examples of prioritized scaling of an evaluation period without an increase in UE power consumption according to one embodiment. In these examples, an evaluation period without scaling is given as 100 ms.

FIG. 5A shows an example of priority scaling for PSCell A (the prioritized or anchor cell), PSCell B, and PSCell C. As the anchor PSCell, N=1 for PSCell A. Thus, a UE evaluates PSCell A every 2×1×100 ms=200 ms (for illustration “A” is shown every 200 ms). As there are two non-anchor PSCells, N=2 for PSCell B and PSCell C, which corresponds to a scaled evaluation period of 2×2×100 ms=400 ms (i.e., “B” and “C” are shown every 400 ms). Thus, in this example, the sampling opportunity for PSCell A (the anchor PSCell) is reduced by 50% (i.e., from every 100 ms to every 200 ms) and the other 50% of the sampling opportunities are split between PSCell B and PSCell C. Compared to the examples shown in FIG. 3A to FIG. 3C, the example shown in FIG. 5A also includes evaluations (or sampling opportunities) only every 100 ms. Thus, the UE provides RLM and/or BFD for an anchor PSCell and two non-anchor PSCells without increasing UE power consumption.

FIG. 5B shows an example of priority scaling for PSCell A (the prioritized or anchor cell), PSCell B, PSCell C, PSCell D, and PSCell E. As the anchor PSCell, N=1 for PSCell A. Thus, the UE evaluates PSCell A every 2×1×100 ms=200 ms (i.e., “A” is shown every 200 ms). As there are four non-anchor PSCells, N=4 for PSCell B, PSCell C, PSCell D, and PSCell E, which corresponds to a scaled evaluation period of 2×4×100 ms=800 ms (i.e., “B”, “C”, “D”, and “E” are shown every 800 ms). Comparing the examples in FIG. 5A and FIG. 5B, the UE maintains the RLM and/or BFD performance for PSCell A without increasing the UE power consumption when going from three PSCells to five PSCells, as the UE performs the same number of evaluations over the illustrated time.

As discussed above, the UE may prioritize more than one PSCell (i.e., more than one anchor PSCell). In certain such embodiments, N=k for each of the anchor cells. For example, FIG. 5C shows an example of priority scaling for five PSCells, with two anchor PSCells (PSCell A1 and PSCell A2) and three non-anchor PSCells (PSCell B, PSCell C, and PSCell D). For anchor PSCell A1 and anchor PSCell A2, N=k=2. Thus, the UE evaluates PSCell A1 and PSCell A2 every 2×2×100 ms=400 ms (i.e., “A1” and “A2” are shown every 200 ms). As there are three non-anchor PSCells, N=3 for PSCell B, PSCell C, and PSCell D, which corresponds to a scaled evaluation period of 2×3×100 ms=600 ms (i.e., “B”, “C”, and “D” are shown every 600 ms). Thus, in this example, 50% of the sampling opportunities are split between the anchor PSCells (PSCell A1 and PSCell A2) and the other 50% of the sampling opportunities are split among the non-anchor PSCells (PSCell B, PSCell C, and PSCell D). However, the UE continues to perform evaluations only every 100 ms, whereby the UE power consumption is not increased.

### UE Capability.

Because a UE may perform RLM and/or BFD simultaneously on multiple candidate or deactivated PSCells, additional UE baseband resources may be used. For example, when there is large number of candidate or deactivated PSCells, additional UE baseband resources may be useful. Thus, in one embodiment, a UE capability message from a UE to a base station may indicate the number of candidate or deactivated PSCells on which the UE can support simultaneous RLM and/or BFD on N candidate SCGs. In another embodiment, the UE capability message indicates the number of candidate or deactivated PSCells on which the UE can be configured to perform RLM and/or BFD on N candidate SCGs.

The UE capability may be per UE. In such embodiments, each UE indicates one number to the network, and the network does not configure RLM and/or BFD on more than the indicated number of candidate or deactivated PSCells. In other embodiments, the UE capability may be per FR wherein the UE indicates a different number in different frequency ranges (FR1 and FR2), per band wherein the UE indicates a different number for cells in different bands, per band combination wherein the UE indicates a different number for cells in different band combinations, or per band per band combination wherein the UE indicates a different number for each band in a given band combination.

### OTHER EXAMPLE EMBODIMENTS

Although certain embodiments disclosed herein are directed to multiple candidate SCGs, the disclosure is not so limited. For example, the embodiments disclosed herein may also be applicable to multiple candidate MCGs. In such embodiments, there may be an indication from network to the UE on RLM and/or BFD-RS sample cycle length for a deactivated primary cell (PCell) (e.g., measCycleDeactivatedPCell). Thus, in the example embodiments disclosed herein, measCyclePSCell may be replaced by measCycleDeactivatedPCell.

Certain of the embodiments disclosed herein may be combined with relaxed RLM and/or BFD, wherein a longer evaluation is assumed (m*Tₑᵥₐₗᵤₐₜₑ) when certain conditions are met. The multiplier, m, may be predefined in a specification or standard (e.g., m=1.5), or selected by a network and explicitly configured to a UE (e.g., m {1.5, 2, 3, 4.5, . . . }. The network may determine to allow relaxed RLM and/or BFD for certain cell(s) (e.g., for non-anchor cells discussed herein).

The conditions for using relaxed RLM and/or BFD may be, for example, those described in 3GPP TS 38.133, clause 8.1.1.1, Requirement on Radio Link Monitoring for UE Configured with Relaxed Measurement Criteria, or those described in 3GPP TS 38.133, clause 8.5.1.1, Requirement on Link Recovery Procedures for UE Configured with Relaxed Measurement Criteria.

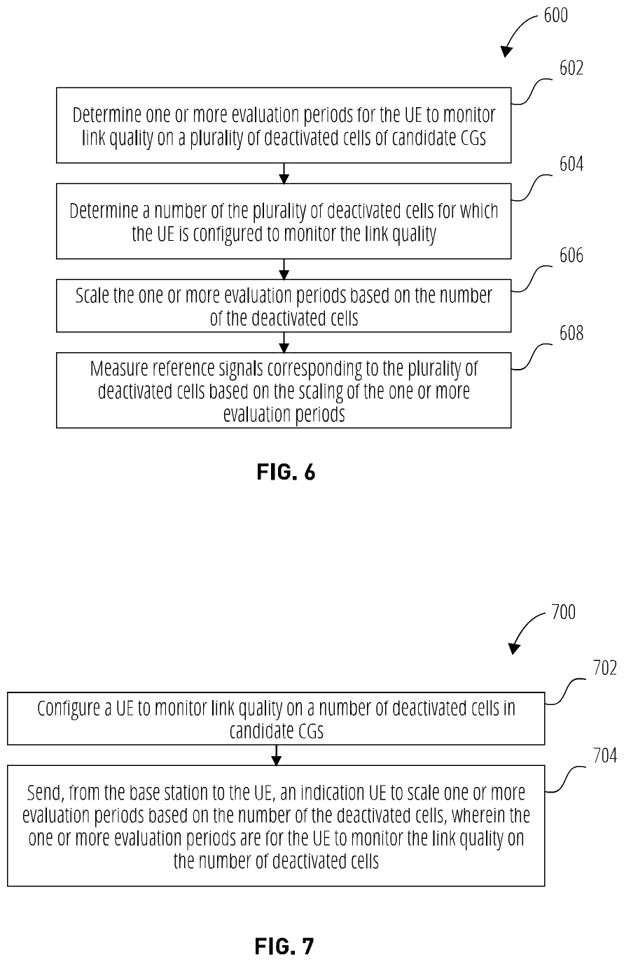

FIG. 6 is a flowchart of a method 600 for a user equipment (UE) to monitor multiple candidate cell groups (CGs) in a wireless network according to one embodiment. In block 602, the method 600 includes determining one or more evaluation periods for the UE to monitor link quality on a plurality of deactivated cells of the candidate CGs. In block 604, the method 600 includes determining a number of the plurality of deactivated cells for which the UE is configured to monitor the link quality. In block 606, the method 600 includes scaling the one or more evaluation periods based on the number of the deactivated cells. In block 608, the method 600 includes measuring reference signals corresponding to the plurality of deactivated cells based on the scaling of the one or more evaluation periods.

In certain embodiments of the method 600, to monitor the link quality comprises to perform at least one of radio link monitoring (RLM) and beam failure detection (BFD) on candidate master cell groups (MCGs) or candidate secondary cell groups (SCGs) in the wireless network.

In certain embodiments of the method 600, the number of the plurality of deactivated cells comprises a total number of the plurality of deactivated cells for which the UE is configured to monitor the link quality, and wherein scaling the one or more evaluation periods comprises multiplying a configured evaluation period by the total number of the plurality of deactivated cells.

In certain embodiments, the method 600 further comprises selecting one or more anchor cells of the plurality of deactivated cells for prioritized monitoring of the link quality, wherein the number of the plurality of deactivated cells comprises a first number of the one or more anchor cells and a second number of non-anchor cells of the plurality of deactivated cells.

In certain embodiments, scaling the one or more evaluation periods comprises: determining a first evaluation period comprising a configured evaluation period without scaling for the one or more anchor cells; and determining a second evaluation period for the non-anchor cells, the second evaluation period comprising the configured evaluation period multiplied by the second number of the non-anchor cells.

In certain embodiments, scaling the one or more evaluation periods comprises: determining a first evaluation period for the one or more anchor cells, the first evaluation period comprising a configured evaluation period multiplied by the first number of the anchor cells; and determining a second evaluation period for the non-anchor cells, the second evaluation period comprising the configured evaluation period multiplied by the second number of the non-anchor cells. In certain such embodiments, the method 600 may further include multiplying the first evaluation period and the second evaluation period by a value to apportion a percentage of sampling opportunities for measuring the reference signals to share among the one or more anchor cells and a remaining percentage of the sampling opportunities for measuring the reference signals to share among the non-anchor cells.

In certain embodiments, selecting the one or more anchor cells comprises receiving, at the UE from a base station, a signal indicating the one or more anchor cells of the plurality of deactivated cells for prioritized monitoring of the link quality. In certain such embodiments, the signal comprises an anchor flag in a cell configuration or a deactivated cell configuration.

In certain embodiments, selecting the one or more anchor cells comprises autonomously determining, at the UE without input from a base station, the one or more anchor cells based on cell measurements. The cell measurements may comprise one or more radio resource management (RRM) measurement selected from a group comprising synchronization signal block (SSB) based reference signal received power (RSRP), SSB based reference signal received quality (RSRQ), SSB based signal to noise and interference ratio (SINR), channel state information (CSI)-reference signal (RS) based RSRP, CSI-RS based RSRQ, and CSI-RS based SINR.

In certain embodiments, the method 600 further includes selecting the one or more anchor cells when a corresponding cell characteristic or quality exceeds a threshold value; and reporting, from the UE to the base station, the one or more anchor cells with the corresponding cell characteristic or quality that exceeds the threshold value.

In certain embodiments, a cell configuration comprises a flag indicating allowable autonomous anchor cell selection by the UE.

In certain embodiments, the method 600 further includes, in response to determining that a relaxed measurement criteria is met for the non-anchor cells, multiplying an evaluation period for measuring the reference signals of the non-anchor cells by a multiplication value, wherein the multiplication value comprises a predetermined value or a configured value communicated to the UE by a base station.

In certain embodiments, the method 600 further includes sending, from the UE to a base station, a UE capability message indicating that the UE is configurable to perform at least one of radio link monitoring (RLM) and beam failure detection (BFD) on a number of candidate master cell groups (MCGs) or candidate secondary cell groups (SCGs) in the wireless network. In certain such embodiments, the UE capability message comprises one of a per UE indication, a per frequency range (FR) indication, a per band indication, a per band combination indication, and per band per band combination indication.

Embodiments contemplated herein include an apparatus comprising means to perform one or more elements of the method 100 or the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 100 or the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 100 or the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 100 or the method 600. This apparatus may be, for example, an apparatus of a UE (such as a wireless device 902 that is a UE, as described herein).

Embodiments contemplated herein include a signal as described in or related to one or more elements of the method 100 or the method 600.

Embodiments contemplated herein include a computer program or computer program product comprising instructions, wherein execution of the program by a processor is to cause the processor to carry out one or more elements of the method 100 or the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

FIG. 7 is a flowchart of a method 700 for a base station in a wireless network according to one embodiment. In block 702, the method 700 includes configuring a user equipment (UE) to monitor link quality on a number of deactivated cells in candidate cell groups (CGs). In block 704, the method 700 includes sending, from the base station to the UE, an indication to scale one or more evaluation periods based on the number of the deactivated cells. The one or more evaluation periods are for the UE to monitor the link quality on the number of deactivated cells.

In certain embodiments of the method 700, configuring the UE to monitor the link quality comprises configuring the UE to perform at least one of radio link monitoring (RLM) and beam failure detection (BFD) on candidate master cell groups (MCGs) or candidate secondary cell groups (SCGs) in the wireless network.

In certain embodiments of the method 700, the number of the deactivated cells comprises a total number of the of deactivated cells for which the UE is configured to monitor the link quality, and wherein the indication to scale the one or more evaluation periods comprises an instruction to multiply a configured evaluation period by the total number of the deactivated cells.

In certain embodiments, the method 700 further includes indicating, from the base station to the UE, one or more anchor cells of the deactivated cells for prioritized monitoring of the link quality, wherein the number of the deactivated cells comprises a first number of the one or more anchor cells and a second number of non-anchor cells of the deactivated cells.

In certain embodiments, the indication to scale the one or more evaluation periods comprises instructions for the UE to: determine a first evaluation period comprising a configured evaluation period without scaling for the one or more anchor cells; and determine a second evaluation period for the non-anchor cells, the second evaluation period comprising the configured evaluation period multiplied by the second number of the non-anchor cells.

In certain embodiments, the indication to scale the one or more evaluation periods comprises instructions for the UE to: determine a first evaluation period for the one or more anchor cells, the first evaluation period comprising a configured evaluation period multiplied by the first number of the anchor cells; and determine a second evaluation period for the non-anchor cells, the second evaluation period comprising the configured evaluation period multiplied by the second number of the non-anchor cells. In certain such embodiments, the instructions are further for the UE to multiply the first evaluation period and the second evaluation period by a value to apportion a percentage of sampling opportunities for measuring the reference signals to share among the one or more anchor cells and a remaining percentage of the sampling opportunities for measuring the reference signals to share among the non-anchor cells.

In certain embodiments, indicating the one or more anchor cells comprises setting an anchor flag in a cell configuration or a deactivated cell configuration.

In certain embodiments, the method 700 further includes indicating, from the base station to the UE, for the UE to autonomously select, based on cell measurements, one or more anchor cells of the deactivated cells for prioritized monitoring of the link quality.

In certain embodiments, the cell measurements comprise one or more radio resource management (RRM) measurement selected from a group comprising synchronization signal block (SSB) based reference signal received power (RSRP), SSB based reference signal received quality (RSRQ), SSB based signal to noise and interference ratio (SINR), channel state information (CSI)-reference signal (RS) based RSRP, CSI-RS based RSRQ, and CSI-RS based SINR.

In certain embodiments, the method 700 further includes: sending, from the base station to the UE, a threshold value for the UE to compare with a corresponding cell characteristic or cell quality; and receiving, at the base station from the UE, a report that the one or more anchor cells include the corresponding cell characteristic or cell quality that exceeds the threshold value.

In certain embodiments, indicating for the UE to autonomously select the one or more anchor cells setting a UE autonomous selection flag in a in a cell configuration or a deactivated cell configuration.

In certain embodiments, the method 700 further includes sending, from the base station to the UE, a multiplication value for the UE to use when a relaxed measurement criteria is met, to further scale the one or more evaluation periods for non-anchor cells.

In certain embodiments, the method 700 further includes receiving, at the base station from the UE, a UE capability message indicating the number of the deactivated cells on which the UE is configurable to perform at least one of radio link monitoring (RLM) and beam failure detection (BFD). In certain such embodiments, the UE capability message comprises one of a per UE indication, a per frequency range (FR) indication, a per band indication, a per band combination indication, and per band per band combination indication.

Embodiments contemplated herein include an apparatus comprising means to perform one or more elements of the method 200 or the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 200 or the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 200 or the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 200 or the method 700. This apparatus may be, for example, an apparatus of a base station (such as a network device 918 that is a base station, as described herein).

Embodiments contemplated herein include a signal as described in or related to one or more elements of the method 200 or the method 700.

Embodiments contemplated herein include a computer program or computer program product comprising instructions, wherein execution of the program by a processing element is to cause the processing element to carry out one or more elements of the method 200 or the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

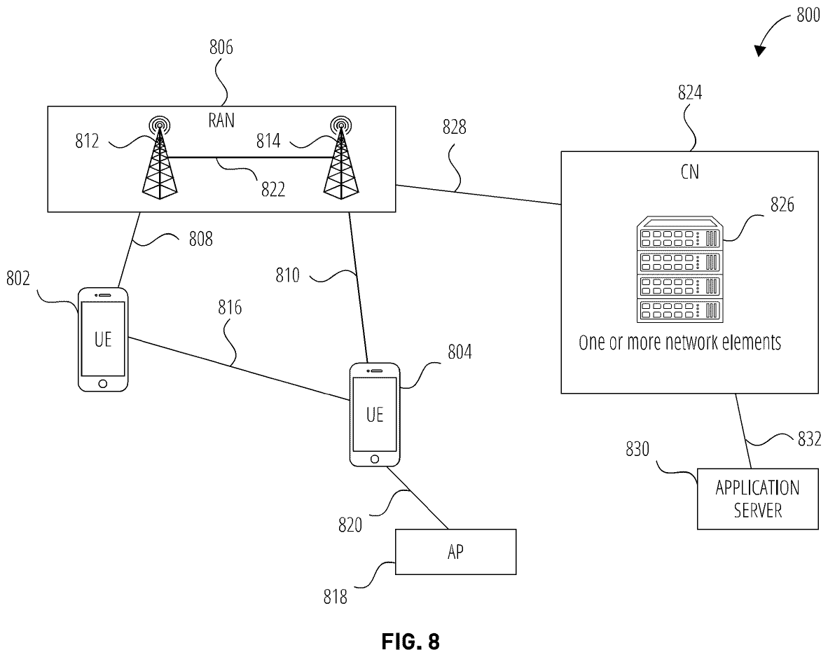

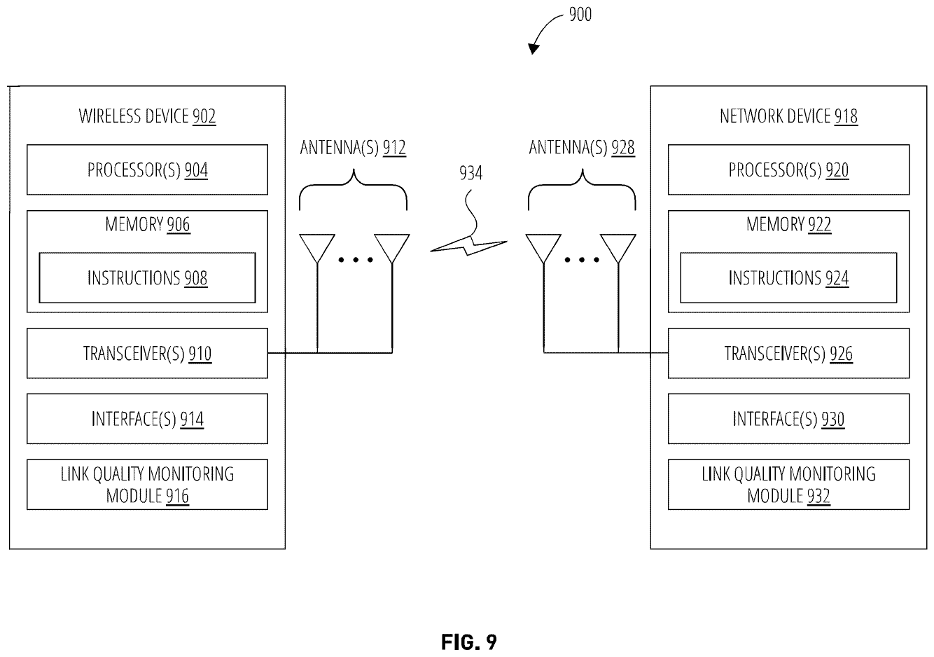

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a link quality monitoring module 916. The link quality monitoring module 916 may be implemented via hardware, software, or combinations thereof. For example, the link quality monitoring module 916 may be implemented as a processor, circuit, and/or instructions 908 stored in the memory 906 and executed by the processor(s) 904. In some examples, the link quality monitoring module 916 may be integrated within the processor(s) 904 and/or the transceiver(s) 910. For example, the link quality monitoring module 916 may be implemented by a combination of software components (e.g., executed by a DSP or a general processor) and hardware components (e.g., logic gates and circuitry) within the processor(s) 904 or the transceiver(s) 910.

The link quality monitoring module 916 may be used for various aspects of the present disclosure, for example, aspects of FIG. 1 and FIG. 6.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a link quality monitoring module 932. The link quality monitoring module 932 may be implemented via hardware, software, or combinations thereof. For example, the link quality monitoring module 932 may be implemented as a processor, circuit, and/or instructions 924 stored in the memory 922 and executed by the processor(s) 920. In some examples, the link quality monitoring module 932 may be integrated within the processor(s) 920 and/or the transceiver(s) 926. For example, the link quality monitoring module 932 may be implemented by a combination of software components (e.g., executed by a DSP or a general processor) and hardware components (e.g., logic gates and circuitry) within the processor(s) 920 or the transceiver(s) 926.

The link quality monitoring module 932 may be used for various aspects of the present disclosure, for example, aspects of FIG. 2 and FIG. 7.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to monitor link quality on multiple candidate cell groups (CGs) in a wireless network, the method comprising:
sending, from the UE to a base station, a UE capability message indicating a number of the candidate CGs for which the UE supports at least one of simultaneous radio link monitoring (RLM) and simultaneous beam failure detection (BFD);
processing, at the UE, a configuration by the base station for measuring reference signals corresponding to a plurality of deactivated cells up to the number of the candidate CGs indicated by the UE capability message; and
measuring the reference signals according to the configuration.

2. The method of claim 1, wherein the configuration comprises measurement cycle length values configured per cell of the plurality of deactivated cells.

3. The method of claim 1, wherein the configuration comprises a deactivated secondary cell group (SCG) configuration information element (IE), received by the UE from the base station, for each of the plurality of deactivated cells.

4. The method of claim 3, wherein the deactivated SCG configuration IE comprises a first indication that the UE is to perform the BFD or the RLM on a corresponding deactivated SCG as part of a candidate SCG selection process.

5. The method of claim 4, wherein the deactivated SCG configuration IE further comprises a second indication that the UE is to report candidate beam information for the corresponding deactivated SCG.

6. The method of claim 3, wherein the deactivated SCG configuration IE comprises a measurement cycle length of a deactivated primary secondary cell (PSCell).

7. The method of claim 3, wherein the deactivated SCG configuration IE comprises at least one of a BFD measurement cycle length and a RLM measurement cycle length of a deactivated primary secondary cell (PSCell).

8. The method of claim 1, wherein the configuration comprises a deactivated master cell group (MCG) configuration information element (IE), received by the UE from the base station, for each of the plurality of deactivated cells.

9. The method of claim 8, wherein the deactivated MCG configuration IE comprises a first indication that the UE is to perform the BFD or the RLM on a corresponding deactivated MCG as part of a candidate MCG selection process.

10. The method of claim 9, wherein the deactivated MCG configuration IE further comprises a second indication that the UE is to report candidate beam information for the corresponding deactivated MCG.

11. The method of claim 8, wherein the deactivated MCG configuration IE comprises a measurement cycle length of a deactivated primary cell (PCell).

12. The method of claim 8, wherein the deactivated MCG configuration IE comprises at least one of a BFD measurement cycle length and a RLM measurement cycle length of a deactivated primary cell (PCell).

13. The method of claim 1, wherein the UE capability message comprises a single value for the number of the candidate CGs for which the UE supports at least one of the simultaneous RLM or the simultaneous BFD.

14. The method of claim 1, wherein the UE capability message comprises one of a per frequency range (FR) indication, a per band indication, a per band combination indication, and per band per band combination indication.

15. The method of claim 1, further comprising, in response to determining that a relaxed measurement criteria is met, multiplying an evaluation period for measuring the reference signals by a multiplication value, wherein the multiplication value comprises a predetermined value or a configured value communicated to the UE by the base station.

16. A method for a base station in a wireless network, the method comprising:
receiving, at the base station from a user equipment (UE), a UE capability message indicating a number of candidate cell groups (CGs) for which the UE supports at least one of simultaneous radio link monitoring (RLM) and simultaneous beam failure detection (BFD); and
providing, by the base station for the UE, a configuration for measuring reference signals corresponding to a plurality of deactivated cells up to the number of the candidate CGs indicated by the UE capability message.

17. The method of claim 16, wherein the configuration comprises measurement cycle length values configured per cell of the plurality of deactivated cells.

18. The method of claim 16, wherein the configuration comprises a deactivated secondary cell group (SCG) configuration information element (IE) for each of the plurality of deactivated cells.

19. The method of claim 18, wherein the deactivated SCG configuration IE comprises a first indication that the UE is to perform the BFD or the RLM on a corresponding deactivated SCG as part of a candidate SCG selection process.

20. The method of claim 19, wherein the deactivated SCG configuration IE further comprises a second indication that the UE is to report candidate beam information for the corresponding deactivated SCG.

21-32. (canceled)
